(19) United States
(12) Patent Application Publication
(10) Pub. No.: US 2009/0129364 A1
(43) Pub. Date: May 21, 2009

(54) METHOD FOR TRANSMITTING AND RECEIVING SAFETY MESSAGE

(75) Inventors: Sang Woo LEE, Daejeon (KR); Hyun Seo OH, Daejeon (KR); Kyeong-Soo HAN, Daejeon (KR); Wan Sik CHOI, Daejeon (KR); Jong-Hyun PARK, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/190,860

(22) Filed: Aug. 13, 2008

(30) Foreign Application Priority Data
Nov. 21, 2007 (KR) 10-2007-0119136

(51) Int. Cl. H04J 3/00

(52) U.S. Cl. 370/345

(57) ABSTRACT

A method for a first mobile station to transmit a safety message to a second mobile station is provided. The first mobile station competitively transmits a non-safety message to the second mobile station during a first period. The first mobile station spreads a safety message and generates a spread message when a second period starts, and transmits the spread message to the second mobile station. Accordingly, safety message transmission delay or data loss in the inter-vehicle communication can be prevented.

### CROSS-REFERENCE TO RELATED APPLICATION

This application claims priority to and the benefit of Korean Patent Application No. 10-2007-0119136 filed in the Korean Intellectual Property Office on Nov. 21, 2007, the entire contents of which are incorporated herein by reference.

### BACKGROUND OF THE INVENTION

(a) Field of the Invention

The present invention relates to a method for transmitting and receiving a safety message.

This work was supported by IT R&D program of MIC/IITA [2007-F-039-01, Vehicle Multi-hop Communication Technology Development].

(b) Description of the Related Art

Communication terminals mounted on vehicles form a communication network and communicate with each other through their own distribution control without control of a base station.

Currently, the IEEE 802.11 carrier sense multiple access/collision avoidance (CSMA/CA) algorithm, which is the wireless LAN standard, is used as a medium access control (MAC) protocol for inter-vehicle communication. When the CSMA/CA algorithm is employed, throughput increases as the number of terminals increases and the throughput decreases when the number of terminals is greater than a specified value.

In CSMA/CA-based inter-vehicle communication, vehicles perform contention-based transmission. A vehicle that wins a competition acquires a radio channel and starts transmission through the radio channel. A vehicle that does not win the competition increases its contention window and again competes for channel access for transmission. When more than two vehicles simultaneously transmit data, collision occurs.

Messages transmitted/received between vehicles in the inter-vehicle communication are classified as safety messages and non-safety messages. The non-safety messages include an entertainment or Internet message for a passenger and a traffic information message. The safety messages include a message related to safety of vehicles and passengers such as an emergency message for informing of an emergency situation, an alert message for preventing vehicular collision, a road condition information message, and so on. The safety messages require a minimum delay time and should be transmitted without any loss of data. In addition, when a safety message is transmitted by using the CSMA/CA algorithm, it must compete for a radio channel with non-safety messages. When the safety message loses the competition, a probability that the safety message can acquire a radio channel is decreased due to a characteristic of the CSMA/CA protocol. Therefore, it becomes difficult to transmit the safety message so that user-required quality of service (QoS) cannot be satisfied.

### SUMMARY OF THE INVENTION

The present invention has been made in an effort to provide a safety message transmitting method and a safety message receiving method that can safely transmit a safety message without delay or data loss.

In an exemplary method for a first mobile station to transmit a safety message to a second mobile station according to an embodiment of the present invention, a non-safety message is transmitted to the second mobile station during a first time period of a time period, and a safety message is transmitted to the second mobile station during a second time period of the time period.

In an exemplary method for a first mobile station to transmit a message to a second mobile station according to another embodiment of the present invention, a non-safety message is competitively received during a first time period of a time period, a safety message is received during a second time period of the time period, and a despread safety message is generated by despreading the safety message.

According to the exemplary embodiments of the present invention, safety message transmission can be performed without delay or loss in the inter-vehicle communication.

### BRIEF DESCRIPTION OF THE DRAWINGS

FIG. 1 shows a channel access method when transmitting a safety message according to an exemplary embodiment of the present invention.

FIG. 2 shows a block diagram of a safety message transmitting apparatus according to the exemplary embodiment of the present invention.

FIG. 3 is a flowchart of a transmission method in the safety message transmission method according to an exemplary embodiment of the present invention.

FIG. 4 is a flowchart of a receiving method in the safety message transmission method according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

Throughout the specification, a mobile station (MS) represents a terminal, a mobile terminal (MT), a subscriber station (SS), a portable subscriber station (PSS), user equipment (UE), and an access terminal (AT), and includes entire or partial functions of the mobile terminal, subscriber station, portable subscriber station, and user equipment.

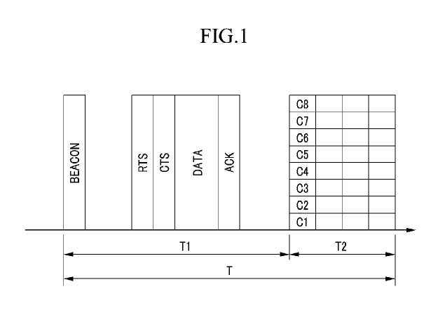

FIG. 1 shows a channel access method when transmitting a safety message according to an exemplary embodiment of the present invention.

As shown in FIG. 1, a radio channel used for communication is time-divided into a section having a regular period T, and the period T is divided into a first period T1 and a second period T2.

A medium access controller according to the exemplary embodiment of the present invention transmits a non-safety message during the first period T1 by using a contention-based method such as a carrier sense multiple access/collision avoidance (CSMA/CA) manner and a carrier sense multiple access/collision detection (CSMA/CD) manner. In addition, the medium access controller spreads a safety message by using a code division multiple access (CDMA) method during the second period T2 and transmits the spread safety message. That is, since the first period T1 and the second period T2 are iterated with a regular cycle, the safety message and the non-safety message can be transmitting without contention.

The safety message and the non-safety message can be generated at any time of the period T. The safety message is buffered when it is generated before the second period T2 of the period T, and is transmitted when the second period T2 starts. The non-safety message is buffered when it is generated after the first period T1 of the period T, and is transmitted when the first period T1 is started again.

In detail, the safety message is transmitted to the MAC unit by using a unique code during the second period T2 in an upper layer. In this instance, the second period T2 includes a plurality of time slots. Herein, the size of one time slot corresponds to time for transmitting one safety message. Each mobile station iterates safety message transmission as many times as the number of time slots during the second period T2.

If a plurality of mobile stations respectively generate a safety message, each mobile station selects one of a plurality of predetermined codes C1 to C8 for transmission of the safety message. In this instance, different mobile stations may select the same code for the message transmission. Then, a receiving mobile station cannot restore the message transmitted from a transmitting mobile station so that the safety message transmission fails due to code collision.

Therefore, a mobile station according to the exemplary embodiment of the present invention uses a code hopping method so that the mobile station changes a code for the safety message transmission. Thus, the plurality of mobile stations simultaneously transmit messages with different codes by using the code hopping method so that the receiving mobile station can restore at least one safety message. For example, it is assumed that a first mobile station transmits a message having codes of {4, 2, 3, 2}, and a second mobile station transmits a message having codes of {4, 1, 3, 4}. Under this assumption, the first code {4} of the first mobile station is the same as that of the second mobile station so that the receiving mobile station cannot restore a message of the first code {4} due to code collision. However, the receiving mobile station can restore messages of the second code {2} of the first mobile station and the second code {1} of the second mobile station, respectively. A mobile station that transmits a safety message uses a predetermined time sequence during a plurality of time slots. The code sequence is set in a random sequence in order to avoid collision with other mobile stations. That is, during the entire second period T2, the sequence of codes is randomly set in order to minimize code collision. For generating the code sequence, a medium access control (MAC) address of each mobile station can be used. When generating the code by using the MAC address, a specific part of the MAC address is used as the code.

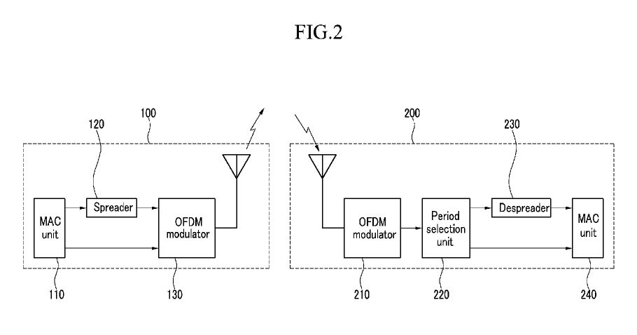

A safety message transmitting apparatus that uses a medium access control address according to an exemplary embodiment of the present invention will be described in further detail with reference to FIG. 2.

FIG. 2 shows a block diagram of the safety message transmitting apparatus according to an exemplary embodiment of the present invention.

As shown in FIG. 2, the safety message transmitting apparatus includes a transmitting mobile station 100 and a receiving mobile station 200.

The transmitting mobile station 100 includes a MAC unit 110, a spreader 120, and an orthogonal frequency division multiplexing (OFDM) modulator 130.

The MAC unit 110 classifies a message transmitted from an upper layer as a safety message or a non-safety message. The MAC unit 110 stores the non-safety message in a non-safety message queue and the safety message in a safety message queue, and provides a waiting time. In addition, the MAC unit 110 transmits the safety message to the spreader 120, and transmits the non-safety message to the OFDM modulator 130.

When the second period T2 of the period T is formed of n time slots, the MAC unit 110 generates n codes and transmits the n codes to the spreader 120.

When the second period T2 starts, the spreader 120 uses the code hopping method to spread the safety message in form of the n codes according to a hopping sequence and transmits the spread safety message to the OFDM modulator 130.

When the first period T1 of the period T starts, the OFDM modulator 130 modulates the non-safety message and transmits the modulated non-safety message to the receiving mobile station 200. In addition, the OFDM modulator 130 modulates the spread safety message and transmits the modulated safety message to the receiving mobile station 200.

The receiving mobile station 200 includes an OFDM demodulator 210, a period selection unit 220, a despreader 230, and a MAC unit 240, and the receiving mobile station 200 may include a plurality of receiving mobile stations 200. The OFDM demodulator 210 demodulates the safety message and the non-safety message transmitted from the transmitting mobile station 100.

Corresponding to the predetermined period T, the period selection unit 220 transmits the demodulated message to the MAC unit 240 during the first period T1 and transmits the demodulated message to the despreader 230 during the second period T2.

The despreader 230 simultaneously despreads a plurality of messages respectively received in form of predetermined codes, and transmits the despread received messages to the MAC unit 240.

The MAC unit 240 transmits the input messages to the upper layer.

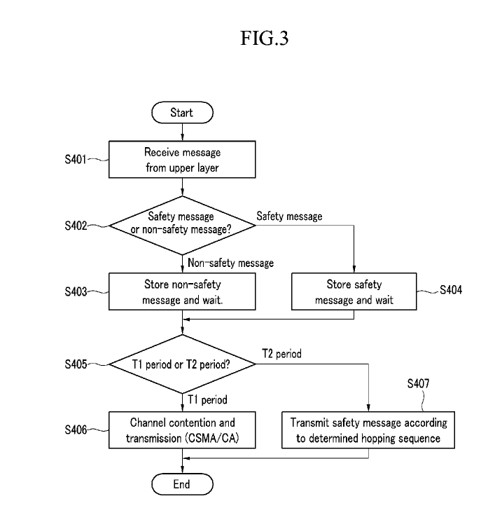

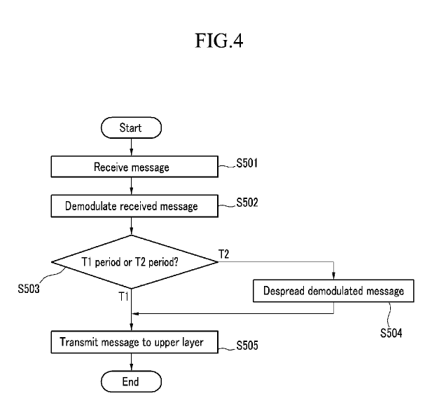

A safety message transmitting method according to the exemplary embodiment of the present invention will be described with reference to FIG. 3 and FIG. 4.

FIG. 3 is a flowchart of a transmitting method of the safety message transmitting method according to the exemplary embodiment of the present invention.

As shown in FIG. 3, the transmitting mobile station 100 of the safety message transmitting apparatus receives a message from the upper layer (S401). The MAC unit 110 classifies the message received in step S401 into a safety message or a non-safety message (S402). The MAC unit 110 stores the classified non-safety message in the non-safety message queue that has a waiting time (S403). In addition, the MAC unit 110 stores the classified safety message in the safety message queue that has a waiting time (S404).

The MAC unit 110 determines whether the current period is the first period T1 or the second period T2 of the period T (S405). When the first period T1 starts, the MAC unit 110 retrieves the non-safety message from the non-safety message queue and transmits the retrieved non-safety message to the OFDM modulator 130. When the second period T2 starts, the MAC unit 110 retrieves the safety message from the safety message queue and transmits the retrieved safety message to the spreader 120.

The OFDM modulator 130 receives the non-safety message and modulates the received message by using a CSMA/CA protocol (S406). The spreader 120 receives the safety message and spreads the received message according to a hopping sequence by using a code hopping method (S407).

The OFDM modulator 130 receives the spread safety message transmitted from the spreader 120 and the non-safety message transmitted from the MAC unit 110, modulates the safety message and the non-safety message, and transmits the modulated messages to the receiving mobile station 200.

FIG. 4 is a flowchart of a receiving method of the safety message transmitting method according to the exemplary embodiment of the present invention.

As shown in FIG. 4, the receiving mobile station 200 of the safety message transmitting apparatus receives a safety message and a non-safety message from the transmitting mobile station 100 (S501). The OFDM demodulator 210 demodulates the safety and non-safety messages received in step S501 (S502).

The period selection unit 220 determines whether the current period is the first period T1 or the second period T2 of the period T (S503). When the first period T1 starts, the period selection unit 220 transmits the demodulated non-safety message to the MAC unit 240. When the second period T2 starts, the period selection unit 220 transmits the demodulated safety message to the despreader 230.

The despreader 230 despreads the demodulated safety message and transmits the despread safety message to the MAC unit 240 (S504).

The MAC unit 240 transmits the safety message and the non-safety message received in steps S503 and S504 to the upper layer (S505).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting at least one safety message, comprising:
transmitting a non-safety message from a first mobile station to a second mobile station during a first period; and
transmitting the safety message to the second mobile station during a second period.

2. The method of claim 1, wherein the transmitting of the non-safety message comprises transmitting the non-safety message by using a contention-based manner.

3. The method of claim 2, wherein the transmitting of the safety message comprises:
spreading the safety message when the second period starts and generating at least one spread message; and
transmitting the spread message to the second mobile station during the second time period.

4. The method of claim 3, wherein the generating of the spread message comprises respectively spreading a plurality of safety messages in form of a plurality of codes and generating a plurality of spread messages, and the transmitting of the spread message comprises transmitting the plurality of spread messages during the second period.

5. The method of claim 4, wherein the transmitting of the plurality of spread messages comprises respectively transmitting the plurality of spread messages during a plurality of time slots of the second period.

6. The method of claim 5, wherein a size of each time slot corresponds to time for transmitting one safety message.

7. The method of claim 4, wherein the generating of the plurality of spread messages comprises generating the plurality of codes by using a specific part of a medium access control (MAC) address.

8. A method for receiving a message, comprising:
receiving a first mobile station a non-safety message from a second mobile station during a first period by using a contention-based manner;
receiving the first mobile station at least one safety message from the second mobile station during a second period of a second period; and
despreading the safety message and generating a despread safety message.

9. The method of claim 8, wherein the receiving of the safety message comprises respectively receiving a plurality of safety messages transmitted from the second mobile station during a plurality of time slots of the second period.

10. The method of claim 8, wherein the generating of the despread safety message comprises respectively dispreading a plurality of safety messages in form of a plurality of codes and generating a plurality of despread messages.
